(19) United States
(12) Patent Application Publication
(10) Pub. No.: US 2014/0015683 A1
(43) Pub. Date: Jan. 16, 2014

(54) DETERRING ELECTRONIC DEVICE USAGE UNDER UNSUITABLE CONDITIONS

(71) Applicants: Manjunath Bharadwaj Subramanya, Bangalore (IN); Harsha Raghavendra Kushtaji, Bangalore (IN); Saurabh Gupta, Bangalore (IN)

(72) Inventors: Manjunath Bharadwaj Subramanya, Bangalore (IN); Harsha Raghavendra Kushtaji, Bangalore (IN); Saurabh Gupta, Bangalore (IN)

(21) Appl. No.: 13/546,796

(22) Filed: Jul. 11, 2012

(51) Int. Cl. G08B 21/18

(52) U.S. Cl. 340/669

(57) ABSTRACT

A system and method for deterring electronic device usage under unsuitable conditions are provided herein. In examples, a position of the electronic device relative to the velocity source and a speed of the device is determined using hardware of the electronic device. Operation of the electronic device under unsuitable conditions is determined using the speed and position of the electronic device. An alert is issued when the electronic device is operated under unsuitable conditions.

### BACKGROUND

The use of electronic devices, such as cellular phones, tablets, and laptops, while operating a vehicle is dangerous. Furthermore, in certain locations, using electronic devices while operating a vehicle is illegal. In general, operating a vehicle is a condition under which using an electronic device should be deterred. Traditional attempts to deter the use of electronic devices while operating a vehicle rely on hardware other than that of the electronic device. The hardware is used to plug into an interface of the vehicle in order to read the vehicle's speed information and obtain other driving behaviors.

### BRIEF DESCRIPTION OF THE DRAWINGS

Certain examples are described in the following detailed description and in reference to the drawings, in which:

FIG. 1 is a block diagram of an electronic device, in accordance with examples;

FIG. 2 is a process flow diagram of a method for deterring the use of an electronic device under unsuitable conditions, in accordance with examples;

FIG. 3 is a process flow diagram of a method for deterring the use of an electronic device under unsuitable conditions, in accordance with examples;

FIG. 4 is a block diagram showing a tangible, non-transitory, computer-readable medium that deters electronic device usage under unsuitable conditions, in accordance with examples.

### DETAILED DESCRIPTION OF SPECIFIC EXAMPLES

As discussed above, attempts to deter the use of electronic devices under unsuitable conditions traditionally focused on accessing the hardware of the vehicle under operation. For example, many vehicles, such as consumer automotives, include an on board diagnostic system with a connector that may be coupled to various tools. The on board diagnostic system may be coupled to a diagnostic tool that is able to retrieve data from the on board diagnostic system and diagnose vehicle malfunctions. The on board diagnostic system may also function as a data logger, and various tools may be connected to the on board diagnostic system in order to retrieve data from the vehicle, such as speed and driver behaviors. Driver behaviors include, but are not limited to, driving style such as heavy use of the brake or quick braking, amount of miles driven, and aggressive driving indicators. By accessing hardware of the vehicle in order to deter use of electronic devices, traditional techniques typically do not take advantage of the hardware already present in an electronic device. For example, cellular phones are usually equipped with global positioning system receivers, proximity sensors, accelerometers, and other hardware that may be used to derive the information that can be obtained from the on board diagnostic system of a vehicle. Furthermore, traditional techniques for deterring use of an electronic device under unsuitable conditions may promote the use of electronic devices while driving by encouraging the operator of a vehicle to interact with the device through auditory signals rather than using hands to control the device.

Systems and methods described herein relate generally to deterring electronic device usage under unsuitable conditions. More specifically, systems and methods described herein relate to deterring electronic device usage by accessing hardware that is already present in the electronic devices. Furthermore, use of the electronic device is discouraged by providing a warning when the electronic device is used under unsuitable conditions.

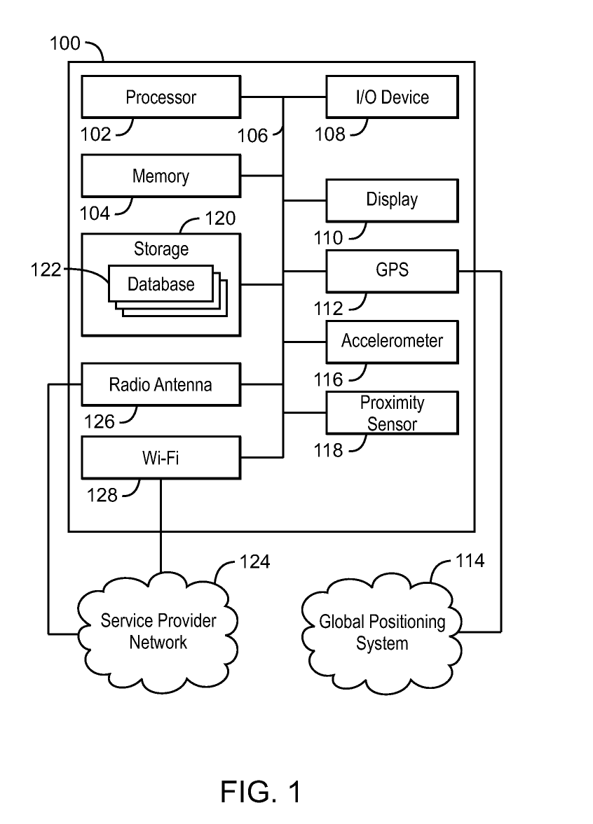

FIG. 1 is a block diagram of an electronic device 100, in accordance with examples. The electronic device 100 may be any type of computing device, such as a mobile phone, laptop computer, or tablet computer, among others. The electronic device 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory (RAM), read only memory (ROM), flash memory, or any other suitable memory systems. The instructions that are executed by the processor 102 may be used to detect a position and a speed of the electronic device, determine if the operation of the electronic device occurs under unsuitable conditions using the speed and the position of the electronic device, and issue an alert when the electronic device is operated under unsuitable conditions.

The processor 102 may be connected through a bus 106 to an input/output (I/O) device 108 adapted to allow a user to interact with the electronic device 100. The I/O device 108 may include, for example, a keyboard and a pointing device, wherein the pointing device may include a touchpad or a touchscreen, among others. In examples, the I/O device 108 may be a touchscreen that includes a virtual keyboard that is rendered on the touchscreen. Additionally, in examples, the I/O device 108 may be externally connected to the electronic device 100, or the I/O device 108 may be internal to the electronic device 100.

The processor 102 may also be linked through the bus 106 to a display 110 adapted to render the output of the electronic device 100. In examples, the display 110 may be a display screen that is external to the electronic device 100. Additionally, in examples, the display 110 and the I/O device may be combined into one touchscreen.

A global positioning system (GPS) receiver 112 may be connected to the bus 106 within the electronic device 100. However in some examples, the GPS receiver 112 may be external to the electronic device 100. Additionally, in examples, the GPS receiver 112 may include, but is not limited to, an antenna, a clock, and a processor. The GPS receiver 112 may wirelessly communicate with the global positioning system 114. The GPS receiver may then provide the geographical location information to other components of the electronic device 100. Information from the GPS receiver 112 may also be used to generate a speed of the electronic device 100. For example, the speed of the electronic device 100 can be calculated based on the position of the electronic device at two points in time, which can be used as an indication of the distance traveled over a specific time period. Furthermore, the speed of the electronic device 100 may be calculated using the GPS receiver 112. In examples, any number of signals from any number of satellites can be used in the calculations to determine the geographical location of the GPS receiver 112. For ease of description, FIG. 1 has been described using the GPS as an example. However, any satellite navigation system may be used to determine the geographical location of the electronic device 100. Thus, the present techniques should not be limited to the GPS, but rather the present techniques include any satellite navigation system presently in use or developed in the future.

In examples the electronic device 100 does not include a GPS receiver 112. In electronic devices without a GPS receiver, triangulation may be used to determine the speed and geographical location of the electronic device. Triangulation is a technique in which an unknown point is determined from angles that are subtended from known points. In examples, the base stations of the service network provider, such as a service network provider 124 (FIG. 1), may be used to provide the known points, while the electronic device can provide the unknown point. Triangulation may be used to determine the speed and geographical location of the unknown point, or electronic device. In examples, other network based mobile phone tracking methods, such as multilateration and forward link timing, may be used to determine the geographical location of the electronic device.

An accelerometer 116 may be connected to the bus 106 within the electronic device 100. In various examples, the accelerometer 116 is used to measure the force of acceleration exerted on the electronic device 100. The accelerometer 116 generally derives the acceleration as a vector quantity. The measured acceleration may be the result of gravity or movement of the electronic device 100. In examples, a measure of acceleration with no corresponding deceleration may be used to detect unsuitable operating conditions, as the acceleration may indicate that the vehicle has started moving. If there is an acceleration with no corresponding deceleration, then the vehicle remains in motion and usage of the mobile device may be unsuitable until a corresponding deceleration is observed. Additionally, the speed of the electronic device 100 may be derived from the force of acceleration that is measured using the accelerometer 116.

A proximity sensor 118 may be connected to the bus 106 within the electronic device 100. The proximity sensor 118 is a sensor that is used to detect nearby objects without physical contact with the nearby objects. The proximity sensor 118 may operate by emitting an electromagnetic field and detecting any changes in the field. The changes in the electromagnetic field enable the proximity sensor 118 to determine how close the sensor is to nearby objects. In this manner, the proximity sensor may be used to provide a three hundred sixty degree scan inside the velocity source, such as a car. A velocity source is any mechanism that may be operated by a user in order provide transportation from one location to another location. In examples, the proximity sensor 118 may be used to determine the electronic device's position relative to the velocity source, such as the interior of a vehicle or other defined space. The electronic device's location relative to the velocity source may be used to determine the electronic device's position within the velocity source, such as the front seat, back seat, passenger's seat, or driver's seat of a velocity source, such as a car.

The electronic device 100 also includes a storage device 120. The storage device 120 can include a hard drive, an optical drive, a thumb drive, an array of drives, a removable memory card, or any combinations thereof. The storage device 120 may include one or more databases 122. In examples, the databases 122 may include lookup tables that can be used to determine a location in a particular country when the GPS receiver has determined the location of the electronic device. The lookup tables may also identify if using an electronic device while operating a vehicle is illegal in a certain geographical location. The lookup tables may also include emergency numbers associated with various geographical locations. The lookup tables can be updated as geographical locations or emergency information change using a service provider network 124.

The service provider network 124 includes a number of base stations that include radio towers. The radio towers within the service provider network 124 may be used to receive signals from electronic devices that access the service provider network 124. Accordingly, the electronic device 100 may send signals to the service provider network 124 using a radio antenna 126. In the case of a cellular phone, the service provider network 124 may connect telephone calls from the cellular phone to another service provider network or to a land-line telephone network in order to complete the call.

Each base station of the service provider network may also possess wireless networking capabilities to allow the electronic device 100 to send and receive data. In examples, the wireless networking capabilities may be a WiFi system. Accordingly, the electronic device 100 may send data to the service provider network using a Wi-Fi antenna 128. The Wi-Fi antenna 128 may also receive data from the service provider network 124. In examples, the data received using the Wi-Fi antenna is used to create or update the database 122 within storage 120.

It is to be understood that the block diagram of FIG. 1 is not intended to indicate that the electronic device 100 is to include all of the components shown in FIG. 1. Further, the electronic device 100 may include any number of additional components not shown in FIG. 1, depending on the design details of a specific implementation.

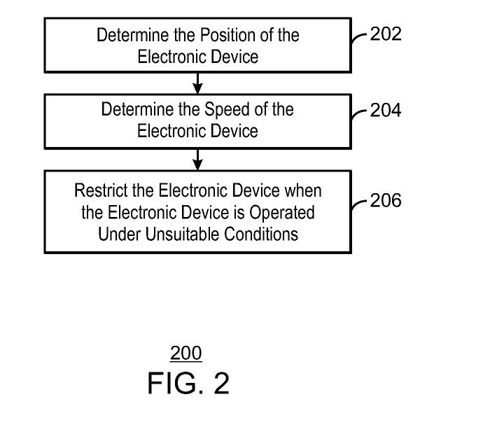

FIG. 2 is a process flow diagram of a method 200 for deterring the use of an electronic device under unsuitable conditions, in accordance with examples. At block 202, a position of the electronic device relative to a velocity source is determined. As discussed above, the velocity source is any mechanism that may be operated by a user in order provide transportation from one location to another location. For example, the velocity source may be a car. A user can operate a car to travel from one location to another location, such as travel between the user's home or workplace. The position of the electronic device relative to the velocity source is determined using the hardware of the device, and does not access the hardware of the velocity source. For example, the position of the device relative to the velocity source may be determined using a proximity sensor, such as the proximity sensor 118 (FIG. 1). The proximity sensor may determine the position of the electronic device within the vehicle, such as the driver's seat, the passenger's seat, or the back seat.

At block 204, a speed of the electronic device is determined. The speed of the device is determined using the hardware of the device. Accordingly, the electronic device does not obtain any information from the hardware of the velocity source. The speed of the device may be determined using information obtained from the GPS receiver or the accelerometer, such as the GPS receiver 114 or the accelerometer 116 (FIG. 1) as discussed above.

At block 208, the electronic device is restricted when the device is operated under unsuitable conditions. In examples, an alert is issued when the device is operated under unsuitable conditions. Additionally, in examples, features of the electronic device may be disabled when the device is operated under unsuitable conditions. In a scenario where the electronic device is a phone, the ability to place a phone call may be disabled. In another scenario where the electronic device is a table computer, video playback may be disabled when the device is operating under unsuitable conditions.

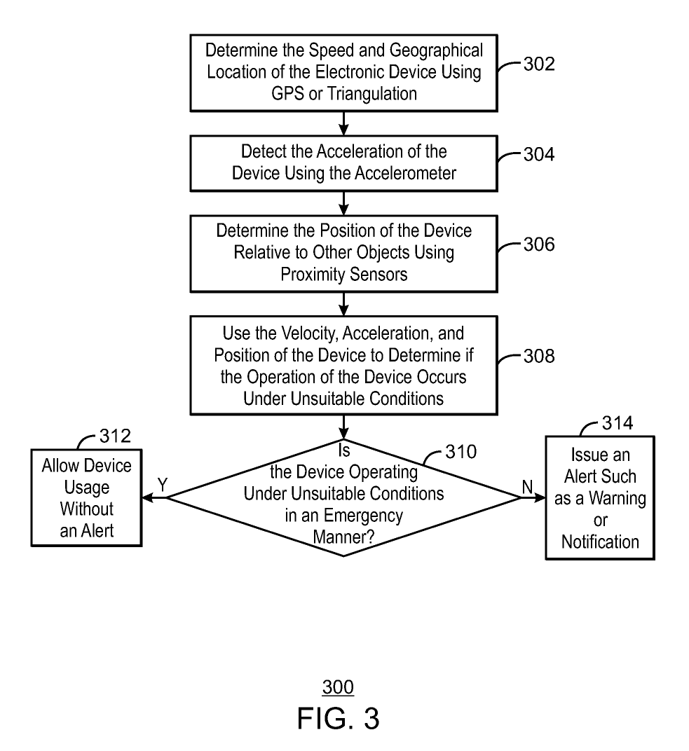

FIG. 3 is a process flow diagram of a method 300 for deterring the use of an electronic device under unsuitable conditions, in accordance with examples. At block 302, the speed and geographical location of the electronic device may be determined using GPS or triangulation. At block 206, the geographical location of the device is determined. In examples, the geographical location of the device may be determined using a positioning system, such as the GPS receiver 114 (FIG. 1). Once the GPS receiver determines a geographical location of the electronic device, a lookup table, such as the lookup table stored in database 122 (FIG. 1), may be accessed in order to determine the country, state, or city where the electronic device is located.

At block 304, the acceleration of the electronic device may be detected using an accelerometer of the electronic device. When the acceleration occurs with no immediately corresponding deceleration, the electronic device may be operated under unsuitable conditions. At block 306, the position of the electronic device relative to objects within the velocity source is used to determine if the operation of the device occurs under unsuitable conditions. The position of the device may be determined using various proximity sensors as discussed above.

At block 308, the speed and position, along with the acceleration and geographical location of the electronic device may be used to determine if the operation of the device occurs under unsuitable conditions. Various factors are used to determine if the conditions are unsuitable for operation. For example, an unsuitable condition may occur when the speed of the velocity source exceeds a certain threshold. However, if the electronic device is positioned in the passenger seat of the vehicle, there is a high probability that the user of the device is not also operating the vehicle. As a result, the device is not operating under unsuitable conditions. The country of location of the device, as derived from the geographical location using the GPS receiver and lookup tables, should also be considered when determining unsuitable conditions. This information may be derived from the geographical location of the electronic device. For example, when the electronic device is located in the United States, the driver seat is positioned on the left side of the vehicle. In contrast, when the electronic device is located in India, the driver seat is located on the right side of the vehicle. A speed above a particular threshold may indicate operation of the device under unsuitable conditions if the device is positioned in the driver seat of the vehicle, as determined by the geographical location of the device. Accordingly, the country of location of the velocity source may also be used to determine if the electronic device is under operation in the driver seat or passenger seat of the velocity source. In examples, a heuristic, such as a phone being charged at a position within the velocity source that is near to the driver's seat, may be used to find a weighted probability that the user is a driver. Another heuristic detects which side of the velocity source is used to enter the interior of the velocity source. In examples, entering the velocity source near the driver's side increases a weighted probability that a user of the device may be a driver. The weighted probability may be used to determine if the device is operating under unsuitable conditions.

At block 310, it is determined if the device is operating under unsuitable conditions in an emergency manner. An emergency manner may be detected when, in the case of a cellular phone, emergency numbers are dialed. The emergency numbers may be stored in a lookup table, such as the lookup table store in database 122 (FIG. 1). In examples, an emergency manner may be detected when the GPS device is used to locate a nearby hospital or police station. Additionally, in examples, a particular contact, telephone number, or activity may be designated as an emergency contact, telephone number, or activity. In examples, a user may designate a particular contact, telephone number, or activity as an emergency contact, telephone number, or activity. The contact, telephone number, or activity may be stored in lookup tables, such as the lookup tables stored in database 122 (FIG. 1). Additionally, in examples, the emergency contact, telephone number, or activity may be automatically updated software stored on the electronic device 100 or the service network provider 124 (FIG. 1). An attempt to use or reach the contact, telephone number, or activity is considered operating the device in an emergency manner.

If the electronic device is operating under unsuitable conditions in an emergency manner, process flow continues to block 312. At block 312, use of the device is allowed. Furthermore, any contact, telephone number, or activity designated as an emergency contact is allowed without issuing an alert. If the electronic device is operating under suitable conditions or if the electronic device is not operating in an emergency manner, process flow continues to block 314.

At block 314, an alert is issued. The alert may be a warning that is rendered on the electronic device that is operating under unsuitable conditions, or a notification that is rendered on a device other than the electronic device. In examples, the alert may be an email, text message, or automated telephone call that is sent to an administrator who wishes to monitor the use of the electronic device. For example, the administrator may be a parent of a child who is the user of the electronic device. Additionally, the administrator may be a supervisor of an employee that operates a motor vehicle within the scope of his employment. The administrator may receive an email, text message, or automated telephone call when the user is operating the electronic device under unsuitable conditions, such as while operating a motor vehicle. The email, text message, or automated telephone call may include information such as the time and geographical location at which the phone was operating under unsuitable conditions.

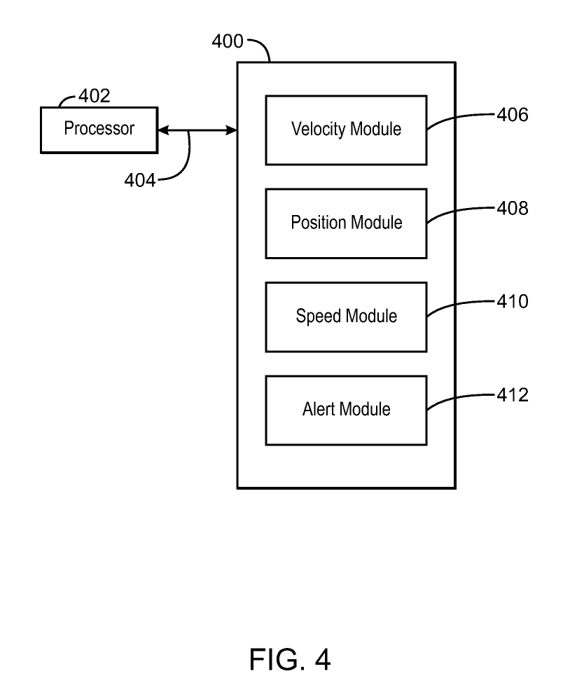

FIG. 4 is a block diagram showing a tangible, non-transitory, computer-readable medium 400 that deters electronic device usage under unsuitable conditions, in accordance with examples. The computer-readable medium 400 may be accessed by a processor 402 over a computer bus 404. Furthermore, the computer-readable medium 400 may include code to direct the processor 402 to perform the steps of the current method.

The various software components discussed herein may be stored on the tangible, non-transitory, computer-readable medium 400, as indicated in FIG. 4. For example, a velocity module 406 may be configured to direct the processor 402 to calculate the speed of the electronic device. A position module 408 may be configured to direct the processor 402 to determine the position of the device relative to the velocity source. In addition, a speed module 410 may be configured to direct the processor 402 determine the speed of the electronic device. An alert module 412 may determine if the operation of the electronic device occurs under unsuitable conditions using the speed and position of the device, and issue an alert when the electronic device is operated under unsuitable conditions.

It is to be understood that FIG. 4 is not intended to indicate that all of the software components discussed above are to be included within the tangible, non-transitory, computer-readable medium 400 in every case. Further, any number of additional software components not shown in FIG. 4 may be included within the tangible, non-transitory, computer-readable medium 400, depending on the specific implementation. For example, location module may be used to determine the geographic location of the electronic device.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method for deterring electronic device usage under unsuitable conditions, comprising:
determining a position of the electronic device relative to a velocity source and a speed of the electronic device using hardware of the electronic device;
determining if operation of the electronic device occurs under unsuitable conditions using the speed and position of the electronic device; and
issuing an alert when the electronic device is operated under unsuitable conditions.

2. The method of claim 1, further comprising:
determining a geographical location of the electronic device using the hardware of the electronic device, wherein a global positioning system receiver of the device is used to determine the geographical location of the electronic device; and
determining if operation of the electronic device occurs under unsuitable conditions using the speed, position, and geographical location of the electronic device.

3. The method of claim 1, further comprising:
determining a geographical location of the electronic device using the hardware of the electronic device, wherein triangulation is used to determine the geographical location of the electronic device; and
determining if operation of the electronic device occurs under unsuitable conditions using the speed, position, and geographical location of the electronic device.

4. The method of claim 1, wherein an acceleration of the device is used to determine if operation of the device occurs under unsuitable conditions.

5. The method of claim 1, wherein the position of the device relative to objects within the velocity source is used to determine if operation of the device occurs under unsuitable conditions.

6. The method of claim 1, wherein the alert is a warning that is rendered on the electronic device.

7. The method of claim 1, wherein the alert is a notification that is rendered on a device other than the electronic device.

8. The method of claim 1, wherein the alert is not issued when the device is operated in an emergency manner.

9. A system for deterring electronic device usage under unsuitable conditions, comprising:
a processor that is adapted to execute stored instructions; and
a storage device that stores instructions, the storage device comprising processor executable code that, when executed by the processor, is adapted to:
determine a position of the electronic device relative to a velocity source and a speed of the electronic device using hardware of the electronic device;
determine if operation of the electronic device occurs under unsuitable conditions using the speed and position of the electronic device; and
issue an alert when the electronic device is operated under unsuitable conditions.

10. The system of claim 9, further comprising:
a global positioning system receiver, wherein the global positioning system receiver of the electronic device is used to determine a geographical location of the electronic device, and the speed, position, and geographical location of the electronic device is used to determine if operation of the electronic device occurs under unsuitable conditions.

11. The system of claim 9, wherein triangulation is used to determine a geographical location of the electronic device, and the speed, position, and geographical location of the electronic device is used to determine if operation of the electronic device occurs under unsuitable conditions.

12. The system of claim 9, wherein an accelerometer is used to determine an acceleration of the electronic device, and the acceleration is used to determine if operation of the electronic device occurs under unsuitable conditions.

13. The system of claim 9, wherein the position of the device relative to objects within the velocity source is used to determine if operation of the device occurs under unsuitable conditions.

14. The system of claim 9, wherein the alert is a warning that is rendered on the electronic device.

15. The system of claim 9, wherein the alert is a notification that is rendered on a device other than the electronic device.

16. The system of claim 9, wherein the alert is not issued when the device is operated in an emergency manner.

17. A tangible, non-transitory, computer-readable medium comprising code to direct a processor to:
determine a position of an electronic device relative to a velocity source and a speed of the electronic device using hardware of the electronic device;
determine if operation of the electronic device occurs under unsuitable conditions using the speed and position of the electronic device; and
issue an alert when the electronic device is operated under unsuitable conditions.

18. The tangible, non-transitory, computer-readable medium of claim 17, further comprising code to direct a processor to:
determine a geographical location of the electronic device using the hardware of the electronic device, wherein a global positioning system receiver of the device is used to determine the geographical location of the electronic device; and
determine if operation of the electronic device occurs under unsuitable conditions using the speed, position, and geographical location of the electronic device.

19. The tangible, non-transitory, computer-readable medium of claim 17, further comprising code to direct a processor to:
determine a geographical location of the electronic device using the hardware of the electronic device, wherein triangulation is used to determine the geographical location of the electronic device; and
determine if operation of the electronic device occurs under unsuitable conditions using the speed, position, and geographical location of the electronic device.

20. The tangible, non-transitory, computer-readable medium of claim 17, wherein the alert is a warning that is rendered on the electronic device.
